(19) United States
(12) Patent Application Publication
(10) Pub. No.: US 2015/0127580 A1
(43) Pub. Date: May 7, 2015

(54) Equalizer

(71) Applicant: Novus Partners, Inc., New York, NY (US)

(72) Inventors: Basil QUNIBI, Astoria, NY (US); Daniel Kushkuley, New York, NY (US); David Cru, New York, NY (US)

(73) Assignee: Novus Partners, Inc., New York, NY (US)

(21) Appl. No.: 14/072,701

(22) Filed: Nov. 5, 2013

(51) Int. Cl. G06Q 40/06

(52) U.S. Cl. CPC G06Q 40/06
USPC 705/36 R

(57) ABSTRACT

A system, method, and computer program product for modeling a risk are provided. An equalizer and an equalizer backend model portfolio risk based on a scenario generated by the equalizer. A scenario includes an active factor, a passive factor, and a change in an active factor level. To model portfolio risk, the equalizer backend uses two-tiered regression analysis. In the first regression, the equalizer backend regresses the passive factor against the active factor and determines changes in a passive factor level. In the second regression, the equalizer backend regresses the changes in the passive and active factor levels against positions in the portfolio that models portfolio risk. The equalizer displays the modeled portfolio risk.

### FIELD

Embodiments relate generally to modeling portfolio risk, and specifically to modeling portfolio risk using a two-tiered regression model.

### BACKGROUND

As part of portfolio management, asset managers evaluate risk to a portfolio that results when the market reacts to a stimuli or change. One way to assess risk is to assess risk for each position (i.e. security) in a portfolio. Another way to assess risk is to determine a portfolio's reaction to market scenarios including market stress. The market scenarios may be based on economic or market stress, stress due to a newsworthy event (such as the Sep. 11, 2001 attack or Lehman Brothers bankruptcy, etc.). To analyze portfolio risk due to market stress, a portfolio needs to be modeled and portfolio returns predicted based upon multiple market factors.

### BRIEF SUMMARY

Embodiments include a system, method and a computer program product for modeling a risk. In an embodiment, an equalizer models portfolio risk based on a scenario. A scenario includes an active factor, a passive factor and a change in an active factor level. To model portfolio risk, the equalizer backend uses a two-tiered regression analysis. In the first regression, the equalizer backend regresses the passive factor against the active factor and determines changes in a passive factor level. In the second regression, the equalizer backend regresses the changes in the passive and active factor levels against positions in the portfolio that model portfolio risk.

Embodiments also include a system, method and a computer program product for configuring a scenario and displaying the modeled portfolio risk. In an embodiment, an equalizer receives indications indicating active and passive factors and a change to the active factor level. Based on the indications, the equalizer generates a scenario. The scenario is transmitted to an equalizer backend for a two-tiered regression that models portfolio risk. The equalizer then receives the results of the two-tiered regression and displays the results to the user. The portfolio risk is displayed in terms of changes to factor levels, factor levels' influence on the portfolio in aggregate and on a per factor basis, and the risk to positions in the portfolio on per position basis.

Further embodiments, features, and advantages of the invention, as well as the structure and operation of the various embodiments, are described in detail below with reference to accompanying drawings.

### BRIEF DESCRIPTION OF THE DRAWINGS/FIGURES

The accompanying drawings, which are incorporated herein and form a part of the specification, illustrate embodiments of the invention and, together with the description, further serve to explain the principles of the embodiments and to enable a person Skilled in the relevant art to make and use the embodiments.

FIG. 1 is a block diagram of client-server environment where an equalizer that determines risk to a portfolio may be implemented.

FIG. 2 is a diagram of an equalizer, according to an embodiment.

FIG. 3A is a block diagram of a scenario, according to an embodiment,

FIG. 3B is a block, diagram of a portfolio, according to an embodiment

FIG. 4 is a Hock diagram of an equalizer back end, according to an embodiment,

FIG. 5 is a block diagram of a factor analyzer and a portfolio analyzer, according to an embodiment.

FIG. 6A and FIG. 6B are examples of source code that includes the functionality of an equalizer, according to an embodiment.

FIG. 7 is a diagram of an equalizer that displays portfolio risk, according to an embodiment.

FIG. 8 is a flowchart of a method for simulating portfolio risk, according to an embodiment.

FIG. 9 is a flowchart of a method for determining market impact for a scenario.

FIG. 10 is a flowchart of a method for simulating portfolio risk based on the market impact, according to an embodiment.

FIG. 11 is a flowchart of a method for generating a scenario and displaying. portfolio risk, according to an embodiment.

FIG. 12 is a computer system where embodiments may be implemented.

Various embodiments will now be described with reference to the accompanying drawings. In the drawings, like reference numbers generally indicate identical or functionally similar elements. Additionally, the left-most digit(s) of a reference number generally identifies the drawing in which the reference number first appears.

### DETAILED DESCRIPTION

The following detailed description refers to the accompanying drawings that illustrate exemplary embodiments consistent with this invention. Other embodiments are possible, and modifications can be made to the embodiments within the spirit and scope of the invention. Therefore, the detailed description is not meant to limit the invention.

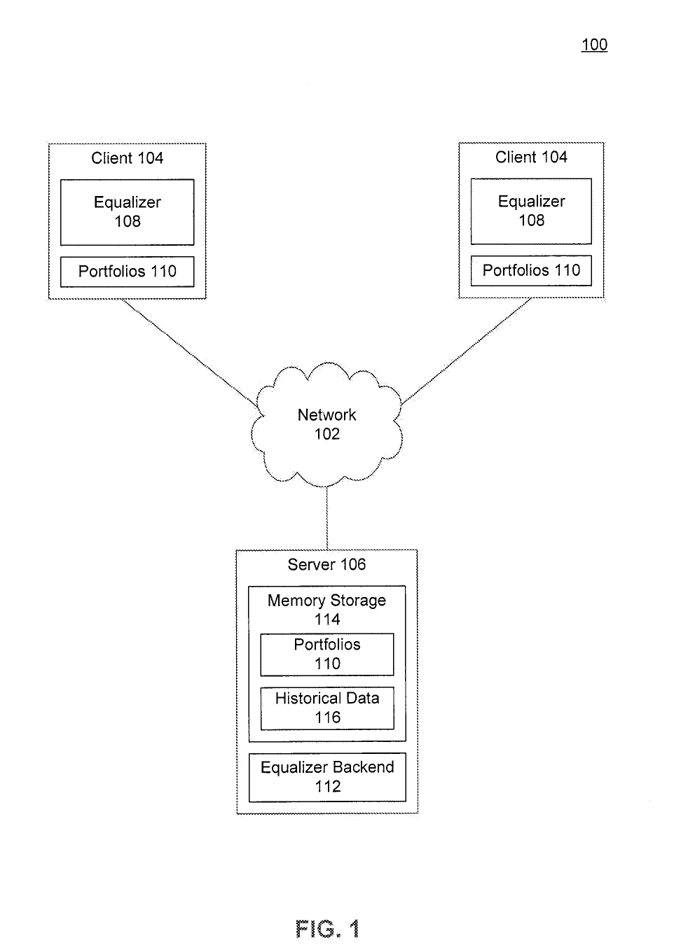

FIG. 1 is a block diagram of client-server environment 100 where an equalizer that determines risk to a portfolio may be implemented, according to an embodiment. Environment 100 includes a network 102, one or more client devices 104, and one or more servers 106.

Network 102 may be any network or combination of networks that can carry data communication. Network 102 may include, but is not limited to, a local area network, metropolitan area network, and/or wide area network such as the Internet. Network 102 can support technologies including, but not limited to, the World Wide Web (“the Web”) that provide access to services and applications using protocols, such as a HyperText Transfer Protocol (“HTTP”). Intermediate web servers, gateways, or other servers may be provided between components of the system shown in FIG. 1, depending upon a particular application or environment.

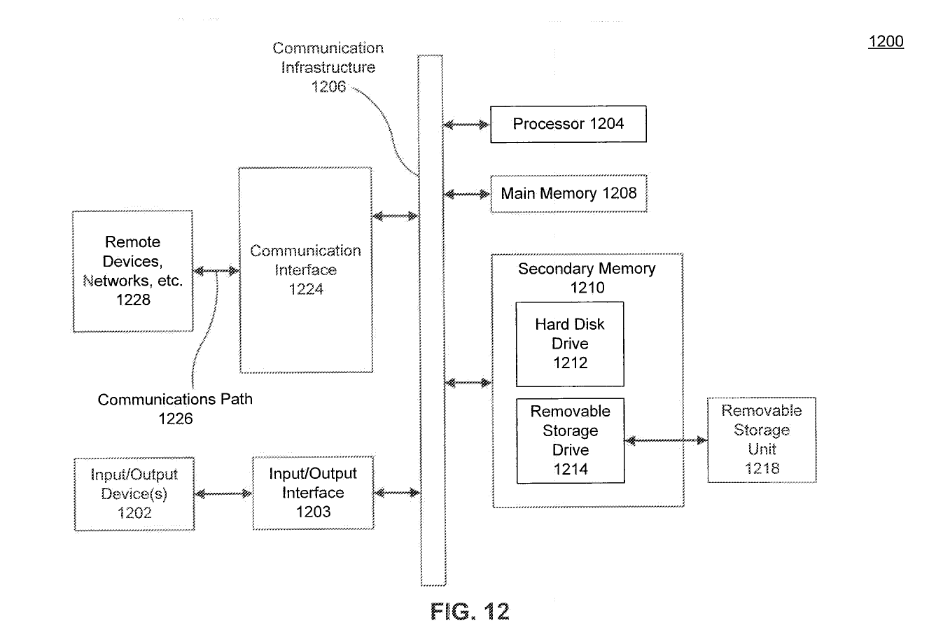

Client device 104 is an electronic device that is controlled and/or manipulated by a user. Client device 104 is capable of requesting and receiving resources, applications, data, etc., over network 102. Examples of client device 104 include personal computers, laptop computers, smartphones, and tablet computers, and any other electronic devices that can connect to network 102. Client device 104 may have some or all components of a computing device included in FIG. 12.

Server 106 is a computing device that communicates with multiple client devices 104. Server 106 may receive requests from client devices 104, process requests and provide responses to the requests that encapsulate data displayed on client devices 104. One component of server 106 may be a web server that issues responses to client device 104 that include HyperText Markup Language (“HTML”) pages, scripts, images, video, etc., to name only a few examples. In an embodiment, the responses to client device 104 also include content, such as words, phrases, images and sounds, that may include embedded information (such as meta-information in hyperlinks) and/or embedded instructions (such as JavaScript scripts). Another component of server 106 may be an application coupled to a database that generates data for transmission to client device 104.

Client devices 104 and servers 106 may access a stock market or other trade-based market. A stock market is an entity that allows economic transactions, such as trades of securities or company stock between multiple market participants that include individual retail investors, institutional investors (hedge funds, mutual funds, investment banks, insurance companies, etc.,) and publicly traded corporations, to give a few examples.

Securities, along with bonds and cash, may be aggregated into a portfolio 110. Portfolios 110 are managed by the above-mentioned market participants and are designed to maximize profit and minimize risk. The amount of profit and risk that each portfolio 110 may undertake typically depends on the investor's trading style, risk tolerance and investment objectives. In an embodiment, portfolio 110 may be stored in a memory storage 114 included or coupled to server 106, or be uploaded for display to client device 104. FIG. 12 is a block diagram that includes various examples of memory devices that may include memory storage 114.

One way to model portfolio risk is to analyze how portfolio 110 reacts to different market conditions, such as daily trading or market stress caused by internal or external events. To model portfolio risk, client-server environment 100 includes an equalizer that includes frontend and backend components. The frontend component of the equalizer (also referred to as equalizer 108) is accessible by way of client device 104. For example, equalizer 108 may be served from server 106 to client device 104, where equalizer 108 is displayed and is operable to receive user input. In an alternative embodiment, equalizer 108 may be installed on client device 104. For example, equalizer 108 may be downloaded from server 106, or uploaded by way of a portable memory drive, such as compact disc or a thumb drive, to name a few examples.

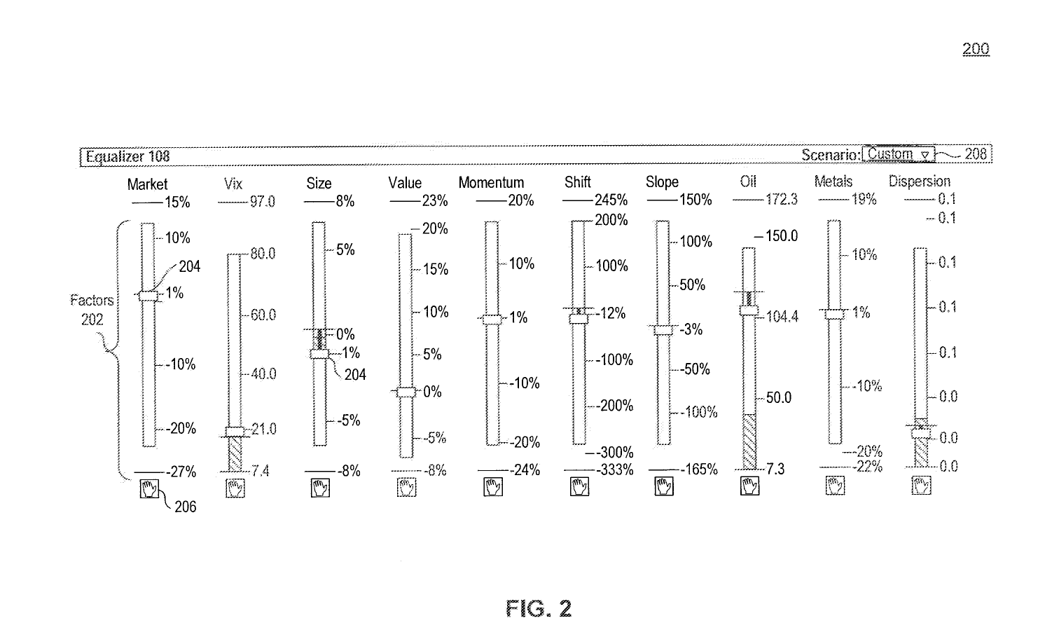

Equalizer 108 uses scenarios to model portfolio risk. In an embodiment, equalizer 108 allows a user to select a scenario from a list of pre-configured scenarios and causes the backend component of equalizer (referred to as equalizer backend 112) to model the risk to portfolio 110 for the selected scenario. In another embodiment, equalizer 108 also allows a user to configure a scenario using multiple market factors, as shown in FIG. 2 and described below.

Server 106 includes an equalizer backend 112. In an embodiment, equalizer backend 112 may be a Java-based module that models portfolio risk, although the implementation is not limited to this embodiment. Risk includes several components. A first component is a value corresponding to the risk of portfolio 110 as the market fluctuates during a trading day. Another component is a risk to portfolio 110 that occurs during market stress caused by major events, such as Sep. 11, 2001 or the Lehman Brothers bankruptcy. Both of these events caused significant stress to the market where the market underwent significant price fluctuation. By modeling the risk to portfolio 110 due to these events, equalizer backend 112 allows an asset manager to analyze portfolio risk and predict portfolio behavior during future events that may cause a stress to the market.

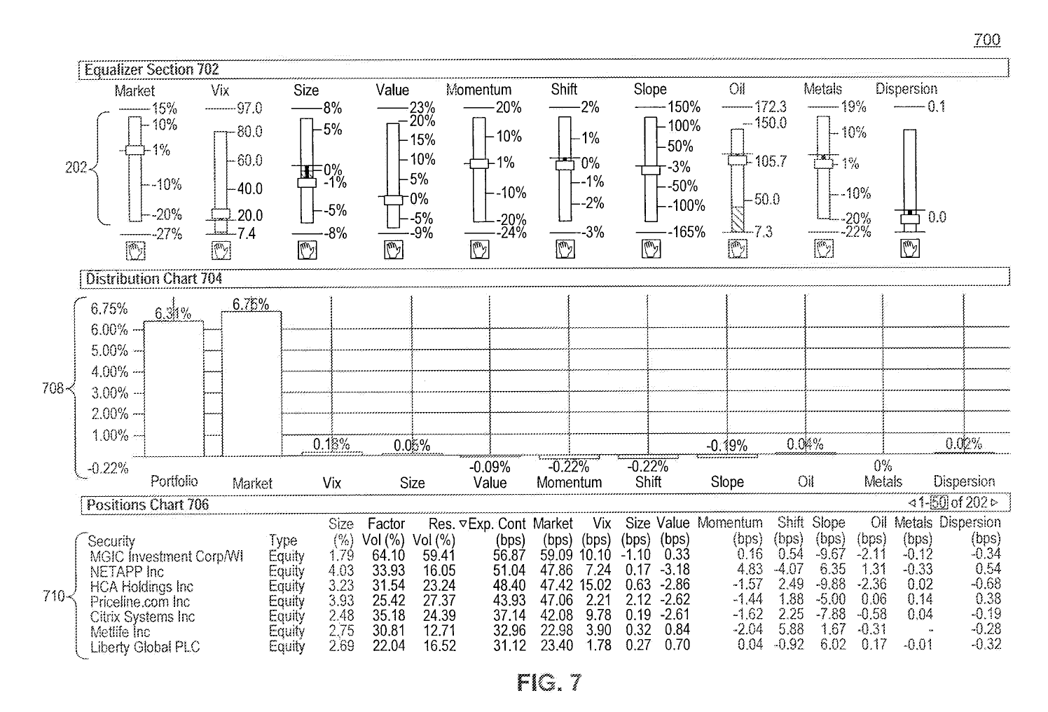

Once equalizer backend 112 determines a risk for portfolio 110 with respect to a selected scenario, equalizer backend 112 causes equalizer 108 to display the risk for the entire portfolio, as well as the risk to each position, as shown in FIG. 7 and described below.

In an embodiment, equalizer backend 112 models portfolio risk based on scenarios generated using equalizer 108 and historical data 116. Historical data 116 may be historical market data or historical data associated with various indices, such as Standard & Poor's 1500®, Russell 3000, volatility indices, etc. In an embodiment, historical data 116 may be stored in memory storage 114 or in a database accessible to server 106 (not shown).

In an embodiment, a scenario may be generated using equalizer 108. FIG. 2 is a diagram 200 of an equalizer 108, according to an embodiment. Equalizer 108 displays multiple factors 202. Factors 202 may be generated using historical data 116, such as historical market data, or be calculated internally. Factors 202 reflect the state of the market on a daily, weekly and monthly basis. Example factors 202 include “market,” “VIX,” “size,” “value,” “momentum,” “shift,” “slope,” “oil,” “metals,” and “dispersion,” but embodiments are not limited to these specific factors.

In an embodiment, the “market” factor includes data from S&P 1500®, which is a stock market index of U.S. stocks that constitute Standard & Poor's. A person skilled in the art will appreciate that S&P 1500® includes three indices, the S&P 500®, the S&P MidCap 400® and the S&P SmallCap 60®, and reflects U.S. market capitalization.

In an embodiment, the “VIX” factor indicates a Chicago Board Options Exchange (CBOE) Volatility Index or VIX® and is a measure of market expectations of near-term volatility as conveyed by the S&P 500® stock index option prices.

In an embodiment, the “size,” “value,” and “momentum” factors are factors from the Fama-French factor model and are calculated based on the constituents of the Russell 3000. A person skilled in the art will appreciate that the Russell 3000 is an index that measures the performance of 3000 publicly held U.S. companies based on market capitalization, and represents approximately 98% of the investible market in U.S.

In an embodiment, the “shift” and “slope” factors are the principal components of the decomposition of the yield curve.

In an embodiment, the “oil” factor indicates the spot price of crude oil.

In an embodiment, the “metals” factor indicates the Goldman Sachs GSCI™ metal index.

In an embodiment, the “dispersion” factor indicates month-to-month cross sectional volatility, and may also be calculated off the constituents of the Russell 3000.

In an embodiment, factors 202 may be configured for a particular market, a particular asset manager (user), a particular asset class or a particular trading strategy. In a further embodiment, a user may select or deselect one or more factors 202. In a further embodiment, a user may choose to exclude one or more factors 202 from modeling the portfolio risk or add additional factors 202.

During the day, the market fluctuates due to trading activity. The fluctuation is reflected in the total change in gains or losses in securities that trade on a market on a particular day. The gains or losses in the market translate to the gains or losses to portfolio 110. On some days, a market fluctuates more than on others. The market fluctuation may be caused by a newsworthy event, which may be an economic event, trading event, bankruptcy event, an initial public offering (an “IPO”), etc. As the market fluctuates, the fluctuation is reflected in a shift in one or more factors 202. For example, on Sep. 11, 2001, the market went down by 9% (“market” factor), volatility increased (“VIX” factor), small-cap stocks outperformed large-cap stocks (“size” and “momentum” factors), value stocks outperformed growth stocks (“value” factor), and the yield shifted down by 2% (“shift” factor). The shift in factors 202 may be used to model a risk to portfolio 110.

An example shift in factor 202 of diagram 200 may be seen in a “size” factor that shifts from 0% to −1%. A shift in factor 202 may be defined as a change in factor level of factor 202, For example, the change in factor level of the “size” factor from 0% to −1% is −1%. In another example, if the “market” factor shifts from 1% to 10%, the change in the factor level is 9%. In an embodiment, a change in a factor level for any factor 202 may occur as a result of the dally trading or market stress.

A portfolio risk may be modeled when one or more factors 202 shift or change factor levels. To assess portfolio risk, equalizer 108 includes sliding fader bars 204 for each factor 202. In an embodiment, a user (such as an asset manager) may set or configure a change in factor levels for one or more factors 202 using respective sliding fader bars 204. In an embodiment, fader bars 204 may also be knobs, input boxes, or other input means that allow a user to change factor levels of factors 202.

In an embodiment, a user using equalizer 108 may assume that some factors 202 constitute more risk to portfolio 110 than other factors 202. To identify these factors 202, equalizer 108 allows a user to set one or more factors 202 as primary factors (also referred to as active factors). However, even though these active factors may significantly influence portfolio risk, the remaining factors (referred to as passive factors, dependent factors and locked factors) also contribute to the portfolio risk. To set factor 202 as an active or passive factor, equalizer 108 includes a lock indicator 206. A user uses lock indicator 206 to lock or set factors 202 to become passive factors. In an embodiment, once a user locks factor 202, the user cannot manipulate fader bar 204 to change the factor level of factor 202. Instead, equalizer backend 112 calculates the change in factor levels associated with the passive factors as a function of the change in the factor level of the active factors, as discussed below.

As shown in FIG. 2, lock indictor 206 is associated with each factor 202. In an embodiment, a user may set multiple factors 202 as passive factors by locking the lock indicator 206 associated with each passive factor.

A scenario is a combination of factors 202 (both passive and active) and factor levels (if any). Based on the scenario, equalizer backend 112 determines portfolio risk to portfolio 110. For example, equalizer 108 may send the scenario to equalizer backend 112, which determines portfolio risk based on the scenario.

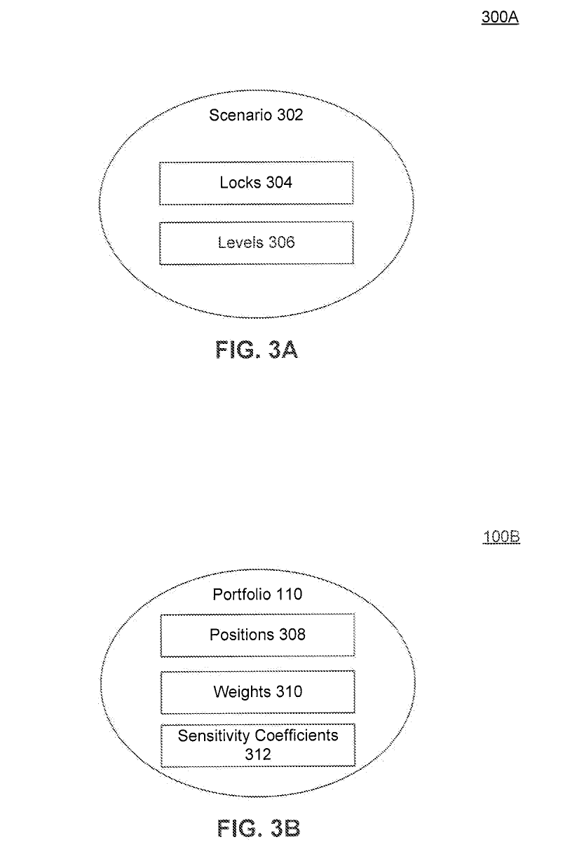

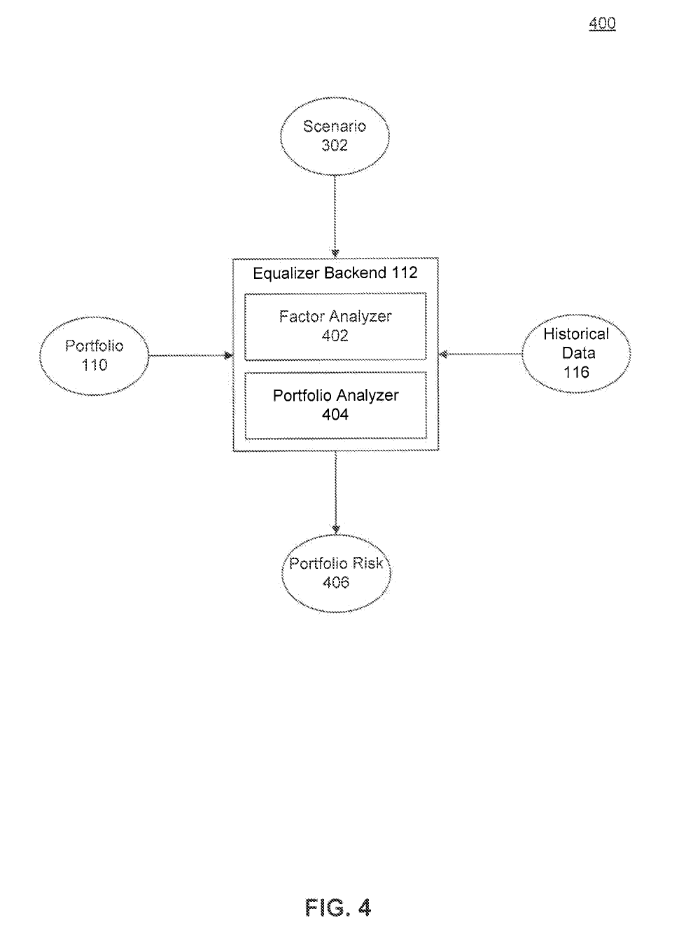

FIG. 3A is a block diagram 300A of a scenario, according to an embodiment. Scenario 302. includes locks 304 and levels 306.

In an embodiment, locks 304 store passive and active factor information for factors 202 that the user set using respective lock indicators 206. information in locks 304 may be represented as a Boolean vector, where ones are associated with the passive factors and zeros are associated with the active factors, although the implementation is not limited to this embodiment.

in another embodiment, levels 306 store changes in factor levels associated with each factor 202. In an embodiment, the change in a factor level for an active factor may be stored as a difference between an old factor level and a new factor level, although the implementation is not limited to this embodiment. In a further embodiment, the levels of the locked factors may be represented as zeros. For example, levels 306 may be represented a vector that includes the difference in active factor levels and zeros associated with passive factor levels.

FIG. 3B is a block diagram 300B of a portfolio, according to an embodiment.

Portfolios 110 may be stored on server 106 or be uploaded for display to client device 104. Portfolio 110 includes positions 308 (also referred to as securities) of an investor or a group of investors on whose behalf a market participant conducts trades. Position 308 is the amount of security that is either owned or borrowed for trading. Each position 308 is associated with a weight 310. In an embodiment, weight 310 corresponds to exposure, which is the market or notional value of the security vis a vis the total sum of portfolio 110.

In an embodiment, each position 308 is also associated with a sensitivity coefficient 312. In an embodiment, sensitivity coefficient 312 may be generated by regressing the market data associated with position 308 against historical data associated with factors 202.

Returning to FIG. 2, in an embodiment, equalizer 108 may also include a scenario list. A scenario list includes scenarios 302 that were previously configured in one embodiment. These scenarios 302 may include changes in factor levels 202 that occurred over a time interval that may be monthly, daily, a variable number of days, etc. In another embodiment, a scenario list may include custom scenarios, such as historical scenarios. Historical scenarios may include, but are not limited to, factors 202 set to factor levels on the day that a historical event has occurred. In an embodiment, the scenario list may be accessed using a drop down menu 208.

When a user completes configuring scenario 302 using equalizer 108, client device 104 transmits scenario 302 to equalizer backend 112. As discussed above, equalizer backend 112 models a risk of scenario 302 on portfolio 110.

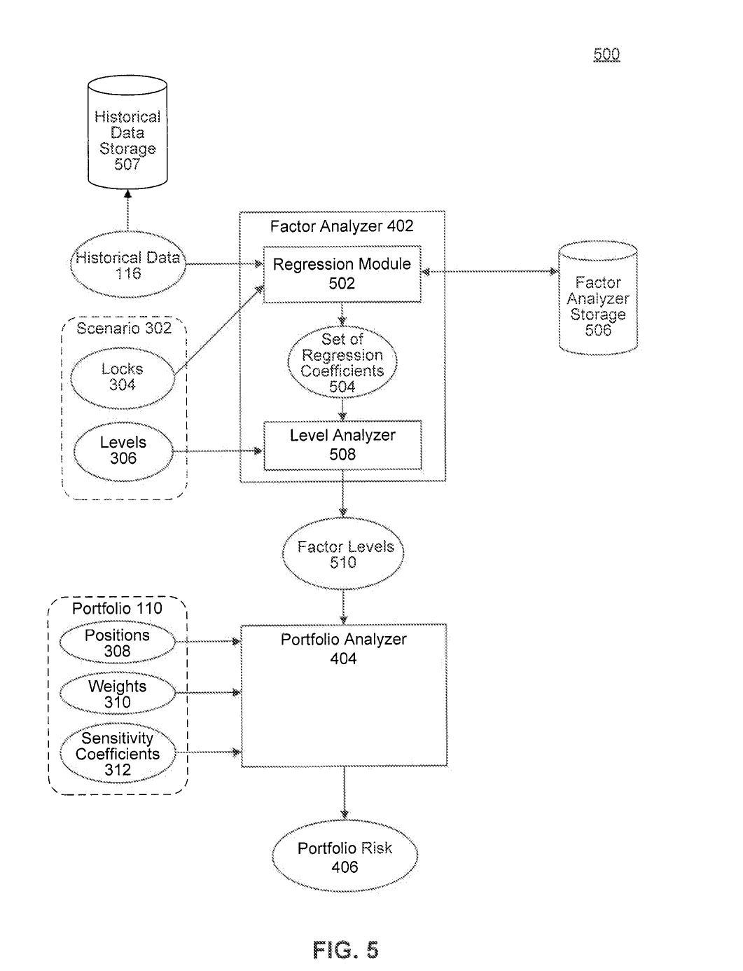

FIG. 4 is a block diagram 400 of an equalizer backend 112, according to an embodiment. Equalizer backend 112 receives scenario 302, portfolio 110 and historical data 116 as inputs. To model the risk to portfolio 110, equalizer backend 112 includes a factor analyzer 402 and a portfolio analyzer 404. Factor analyzer 402 and portfolio analyzer 404 form a two-tier regression mechanism that equalizer backend 112 uses to model portfolio risk.

Factor analyzer 402 determines market impact based on scenario 302. For example, once factor analyzer 402 receives scenario 302, factor analyzer 402 identifies passive and active factors using locks 304 and regresses the passive factors against the active factors. The regression determines the change in level factors of passive factors. Factor analyzer 402 then passes the changes in factor levels of passive and active factors to portfolio analyzer 404.

Portfolio analyzer 404 then uses the changes in factor levels as generated by factor analyzer 402 to model a risk to portfolio 110. The modeled portfolio risk is transmitted for display to equalizer 108 as portfolio risk 406. Portfolio risk 406 includes changes in factor levels for factors 202, risk on per position basis as associated with each factor 202, and risk to portfolio 110 as a whole.

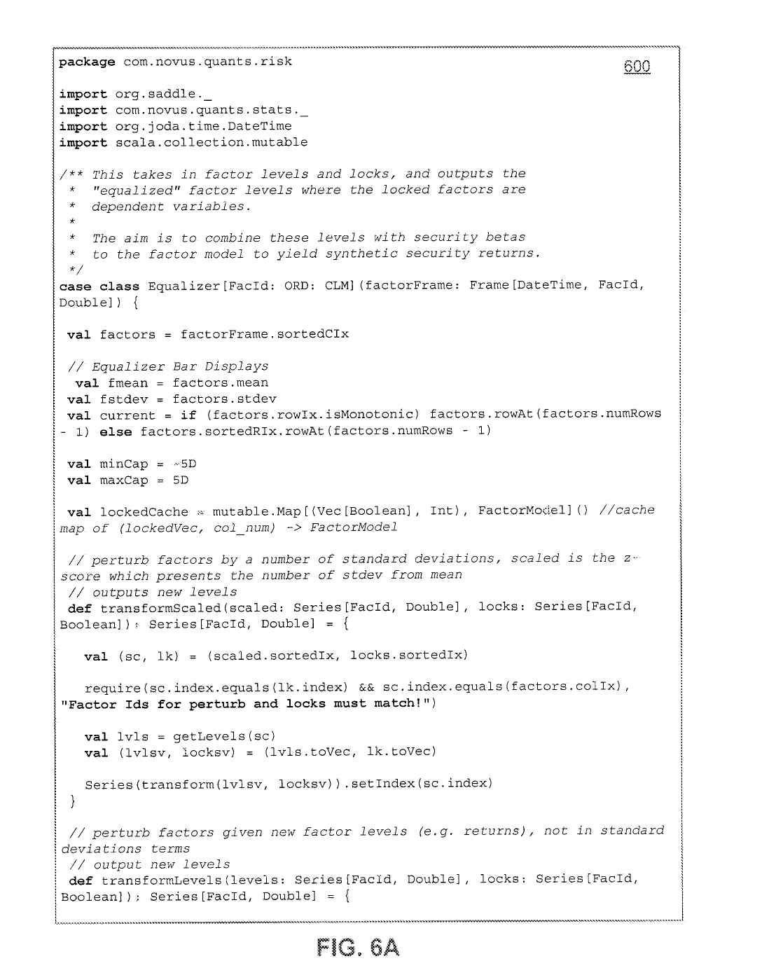

FIG. 5 is a block diagram 500 of a factor analyzer and a portfolio analyzer, according to an embodiment.

Factor analyzer 402 includes a regression module 502. Regression module 502 retrieves locks 304 from scenario 302 and identifies factors 202 that are passive and active factors. For example, regression module 502 may interpret the ones in the Boolean vector as active factors and zeros as passive factors.

Regression module 502 then regresses the set of passive factors against the active factors. For instance, if locks 304 in scenario 302 indicate that the “market” factor is an active factor, and “VIX,” “size,” “value,” “momentum,” “Shift,” “slope,” “oil,” “metals,” and “dispersion” factors are passive factors, factor analyzer 402 runs nine regressions (one for each passive factor) against the “market” factor (active factor).

As part of the regression, regression module 502 uses historical data 116 to regress the set of passive factors against one or more factors and generate a regression coefficient beta for each factor 202. In an embodiment, the set of regression coefficients for factors 202 is referred to as a set of betas 504, with a beta per factor. In an embodiment, regression module 502 stores the set of betas 504 in memory storage, such as factor analyzer storage 506. Factor analyzer storage 506 may be implemented as one of the memories discussed in FIG. 12. Factor analyzer 402 stores set of betas 504 in factor analyzer storage 506 in the event equalizer 108 sends another scenario 302 to equalizer backend 112 having the same set of active and passive factors. In this case, regression module 502 retrieves the set of betas 504 from factor analyzer storage 506 and bypasses the linear regression calculation. In one embodiment, regression module 502 compares the respective locks 304 of different scenarios 302 to determine whether the different scenarios 302 include the same set of active and passive factors.

In an embodiment, regression module 502 uses historical data 116 to regress active and passive factors. Historical data 116 may be set to a monthly or daily mode. For example, in a monthly mode, regression module 502 uses historical data 116 at monthly intervals to regress the passive factors against the active factors. In a daily mode, regression module 502 uses historical data 116 at daily intervals, such as five, ten or twenty days, to regress the passive factors against the active factors.

In an embodiment, equalizer backend 112 stores historical data 116 in historical data storage 507. Historical data storage 507 may be a database that stores data indexed according to a particular time. For example, historical data may be indexed according to time “X” intervals, and data for “market,” “VIX,” “size,” “value,” “momentum,” “shift,” “slope,” “oil,” “metals,” and “dispersion” factors may be stored at these time “X” intervals, as historical data 116 disseminated by markets may be time-stamped with a particular date. In an embodiment, historical data 116 may be retrieved from historical data storage 507 using a Hierarchical Data Format (“HDF”), such as, HDF5, though the implementation is not limited to that embodiment. A person skilled in the art will appreciated that HDF may be used for efficient storage and retrieval of large quantities of hierarchical and structured data.

Factor analyzer 402 also includes a level analyzer 508. Level analyzer 508 determines the Change in factor levels for the passive factors based on the set of betas 504 and levels 306. As discussed above, scenario 302 may include levels 306 that represent changes in the active factor levels as ones and represents changes to passive factor levels as zeros. Level analyzer 508 determines the change in factor levels for passive factors by multiplying the beta for each factor by the change in the factor level associated with the active factor. For example, if the change in the factor level for the market factor (designated as active) is 1%, level analyzer 508 multiplies each beta in the set of betas 504 by 1%. Level analyzer 508 then adjusts the passive factor levels by the results of the corresponding beta multiplied by the change in the active factor level, i.e. by the result of beta multiplied by 1%.

In an embodiment, when level analyzer 508 generates the passive factor levels, level analyzer 508 passes factor levels 510 to portfolio analyzer 404. Factor levels 510 include the active factor levels from levels 306 and passive factors levels calculated using level analyzer 508.

Portfolio analyzer 404 determines risk to portfolio 110 as portfolio risk 406. In an embodiment, portfolio analyzer 404 uses portfolio 110 and factor levels 510 as inputs and determines a risk to portfolio 110 as a whole and on a per position basis. For example, portfolio analyzer 404 retrieves sensitivity coefficients 312 associated with each position 308. Once retrieved, portfolio analyzer 404 determines a dot product of the sensitivity coefficients 312 with a factor level for each factor 202 from factor levels 510, and generates a contribution of each factor 202 toward risk for each position 308. Next, portfolio analyzer 404 determines a linear combination of weight 310 associated with each position 308 and the contribution of each factor 202 toward the risk for each position 308. The result of the linear combination is the adjusted effect of the change in factor level of each factor 202 on each position 308 as the function of the position's weight in portfolio 110. Finally, portfolio analyzer 404 aggregates the adjusted effect of the factor 202 on each position 308 to determine the effect of change in factor level of each factor 202 on portfolio 110, as well as total risk for portfolio 110. Once portfolio analyzer 404 determines the total portfolio risk, portfolio analyzer 404 transmits portfolio risk 406 to equalizer 108. In an embodiment, portfolio risk 406 includes changes in factor levels for factors 202, effects of the changes in factor levels of factors 202 on each position 308 and on portfolio 110 as a whole, risk to portfolio 110 as a whole and portfolio risk that is associated with each factor 202.

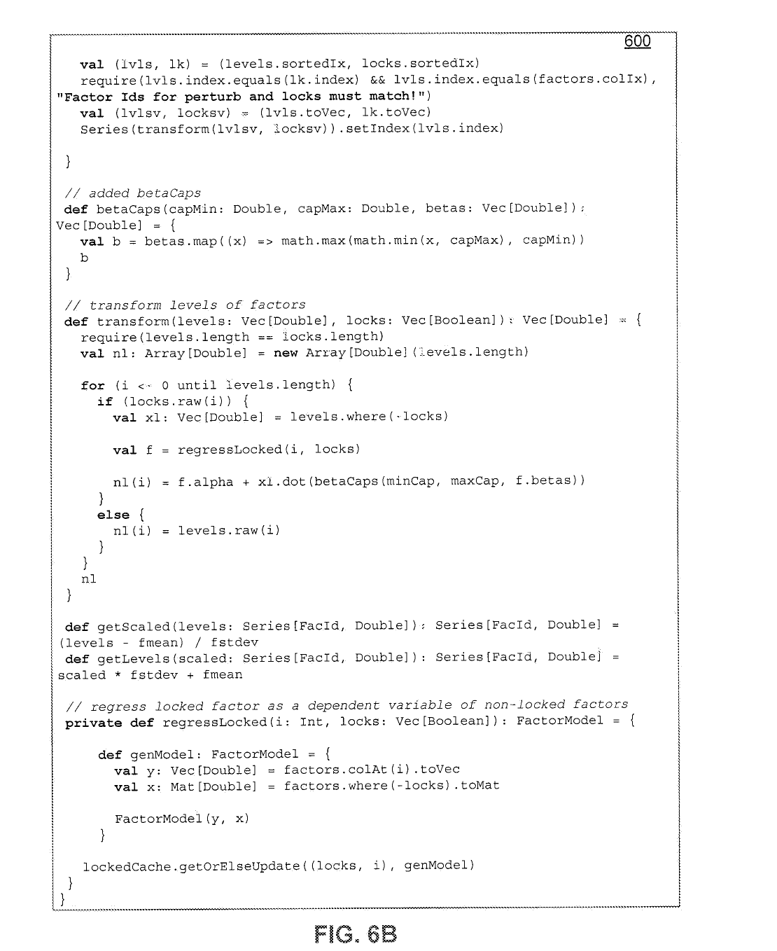

FIG. 6A and FIG. 6B are diagrams of source code 600 that include the functionality of an equalizer, according to an embodiment. Source code 600 is written in Scala, a programming language well known to a person of ordinary skill in the art, and includes the functionality of factor analyzer 402, though the implementation is not limited to this embodiment.

FIG. 7 is a diagram 700 of an equalizer that displays portfolio risk, according to an embodiment.

Equalizer 108 shows the portfolio risk 406 simulated using equalizer backend 112. Equalizer 108 includes an equalizer section 702, distribution chart 704 and positions chart 706, in an embodiment.

Equalizer section 702 displays changes in factor levels of factors 202. For example, when the user changes the level of an active factor, equalizer backend 112 simulates the change in the passive factor levels and displays the change in equalizer section 702. For example, when the level of the “market” factor (active factor) changes by 1%, the “size” factor incurs a change in level of −1%, and the levels of other passive factors also change as calculated by equalizer backend 112.

Distribution chart 704 displays portfolio risk 406 in aggregate and on a per factor basis, as shown in section 708. For example, distribution chart 704 demonstrates that when factors 202 are at levels shown in equalizer section 702, the value of the portfolio 110 increases by 6.31%. Distribution chart 704 also demonstrates how each factor 202 affects portfolio risk on per factor basis. For example, when the overall “market” factor increases by 1%, the “market” factor associated with the portfolio increases by 6.75%. In another example, when the overall “size” factor decreases by 1%, the “size” factor of the portfolio increases by 0.05%. In an embodiment, section 708 is an aggregate of each factor level change displayed in positions chart 706.

Positions chart 706 includes positions 308 included in portfolio 110. In an embodiment, positions chart 706 displays the effects of factor level changes on positions 308 as shown in section 710. In an embodiment, the contribution of the factor level change of each factor 202 for each position 308 may be displayed as basis points (bps), defined as 1/100 of 1%. For example, the Liberty Global PLC security had a 23.40 bps change in its individual “market” factor based on the overall “market” factor change of 1%. In another example, the Liberty Global PLC security had a 0.27 bps change in its individual “size” factor based on the approximately −1% change in the overall market's “size” factor.

In an embodiment, position chart 706 displays positions 308 as a series of pages that a user scrolls through as the user analyzes the effect of factor level changes of factors 202 on each position 308 in portfolio 110.

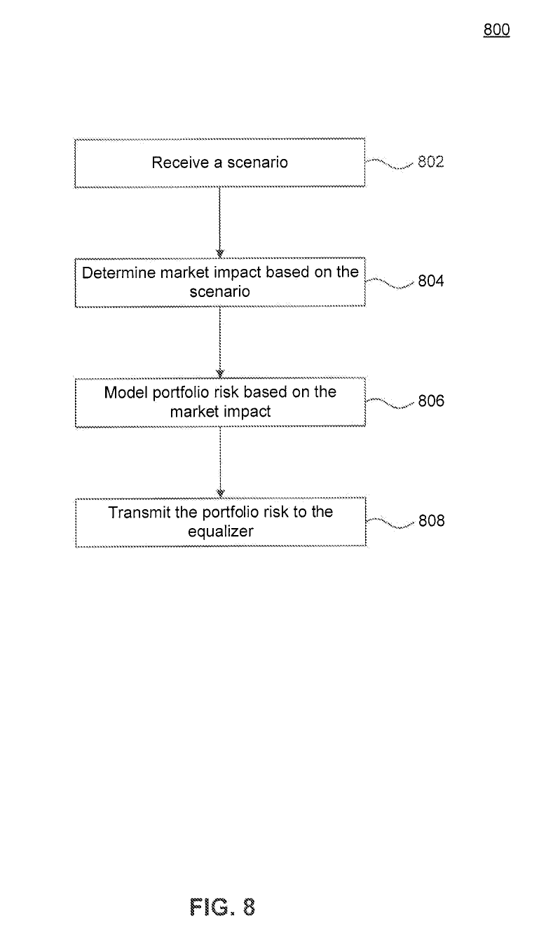

FIG. 8 is a flowchart of a method 800 for simulating portfolio risk, according to an embodiment.

At step 802, a scenario is received. For instance, equalizer backend 112 may receive scenario 302 generated using equalizer 108. Scenario 302 includes locks 304 and levels 306. As discussed above, locks 304 indicate active and passive factors and levels 306 indicate the changes in the active factor levels.

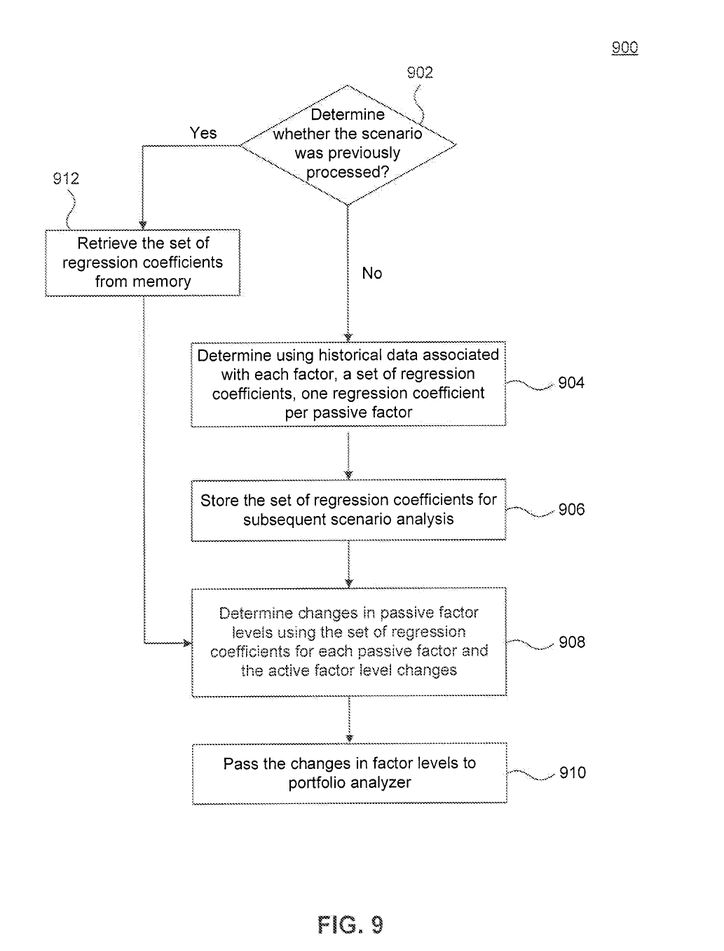

At step 804, a market impact is determined based on the scenario. For instance, factor analyzer 402 may receive scenario 302 and generate factor levels 510 that indicate changes in factor levels of factors 202. FIG. 9 is a flowchart of a method 900 that describes step 804 and is discussed below.

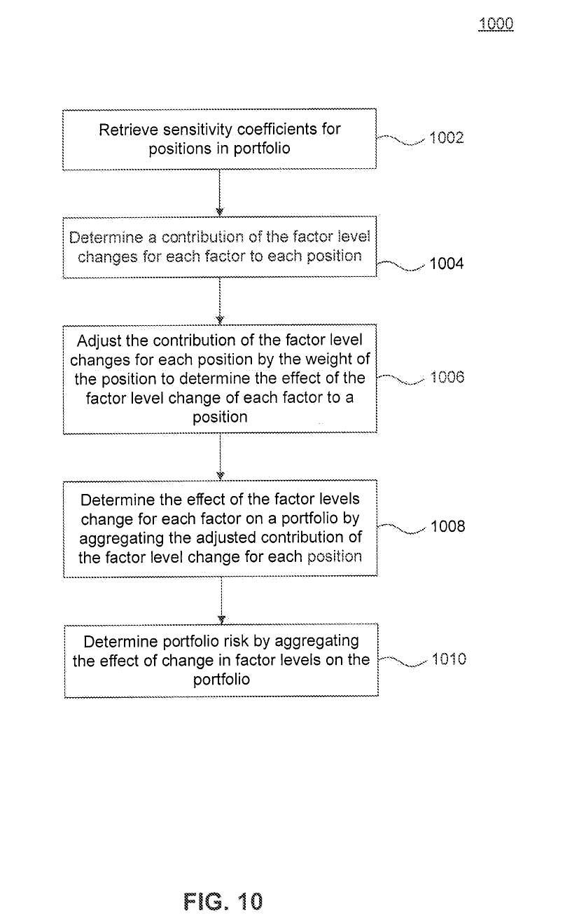

At step 806, a portfolio risk is determined. For instance, portfolio analyzer 404 may receive factor levels 510 from factor analyzer 402, and uses factor levels 510 to model portfolio risk 406 of portfolio 110 as a whole and on a per position 308 basis. FIG. 10 is a flowchart of a method 1000 that describes step 806 and is discussed below.

At step 808, the modeled portfolio risk is transmitted for display. For example, equalizer backend 112 may transmit the modeled portfolio risk 406 for display using equalizer 108.

FIG. 9 is a flowchart of a method 900 for determining market impact for a scenario.

At step 902, it is determined whether a scenario with the same active and passive factors was previously processed. For instance, factor analyzer 402 may determine whether scenario 302 with the same active and passive factors was previously processed. To make the determination, factor analyzer 402 compares locks 304 from scenario 302 received in step 802 to locks 304 from the previously processed scenarios 302. If scenario 302 received in step 802 is processed for the first time, the method proceeds to step 904. Otherwise, the method proceeds to step 912.

At step 904, a set of regression coefficients is determined For instance, factor analyzer 402 may identify passive and active factors from locks 304. Once identified, factor analyzer 402 performs the first regression and generates a set of regression coefficients, such as set of betas 504, with a beta per factor. Set of betas 504 are generated by regressing passive factors against active factors and using historical data 116 associated with factors 202.

At step 906, the set of betas is stored for subsequent scenario analysis. For instance, factor analyzer 402 stores set of betas 504 generated using locks 304 in factor analyzer storage 506. In this way, the first tier regression in step 904 can be skipped if factor analyzer 402 receives another scenario 302 having the same locks 304.

At step 908, changes in the levels of passive factors are determined. For instance, factor analyzer 402 may retrieve levels 306 associated with active factor level changes. Factor analyzer 402 then generates the change in levels for the passive factors by multiplying each beta in set of betas 504 associated with each passive factor by the change in levels associated with the active factors. Factor analyzer 402 then adjusts the factor level of each passive factor by the results of the corresponding beta multiplied by the change in the active factor level.

At step 910, the changes in the factor levels are analyzed. For instance, factor analyzer 402 may send factor levels 510 associated with passive factors and active factors to portfolio analyzer 404.

Returning to step 902, where equalizer backend 112 previously has processed scenario 302, the method proceeds to step 912. At step 912, the set of betas is retrieved from memory. For example, factor analyzer 402 retrieves the set of betas 504 for scenario 302 from factor analyzer storage 506, and proceeds to step 908.

FIG. 10 is a flowchart of a method 1000 for modeling portfolio risk, according to an embodiment. Prior to step 1002, changes to the passive and active factor levels are received.

At step 1002, sensitivity coefficients for positions in the portfolio are retrieved. For instance, portfolio 110 may include sensitivity coefficients 312 associated with positions 308. Portfolio analyzer 404 retrieves sensitivity coefficients 312.

At step 1004, a contribution of the factor level change for each factor is determined on a per position basis. For example, portfolio analyzer 404 may determine a dot product of the sensitivity coefficients 312 and the factor level change for each factor 202 using factor levels 510.

At step 1006, a contribution of the factor level change of each factor to a position is adjusted by the position's weight in the portfolio. For example, portfolio analyzer 404 may determine a linear combination of weight 310 associated with position 308 and the contribution of the factor level change for each factor 202. The linear combination is the effect of the factor level change of each factor 202 on each position 308 as a function of the position's weight 310 in portfolio 110.

At step 1008, an effect of each factor level change on a portfolio is determined For example, portfolio analyzer 404 may aggregate the adjusted contribution of each factor level for all positions 308 and determine the change in portfolio 110 associated with the factor level change of each factor 202.

At step 1010, a risk for the portfolio is determined. For example, portfolio analyzer 404 may aggregate the effect of the factor level change for each factor 202 on portfolio 110 and determines portfolio risk 406.

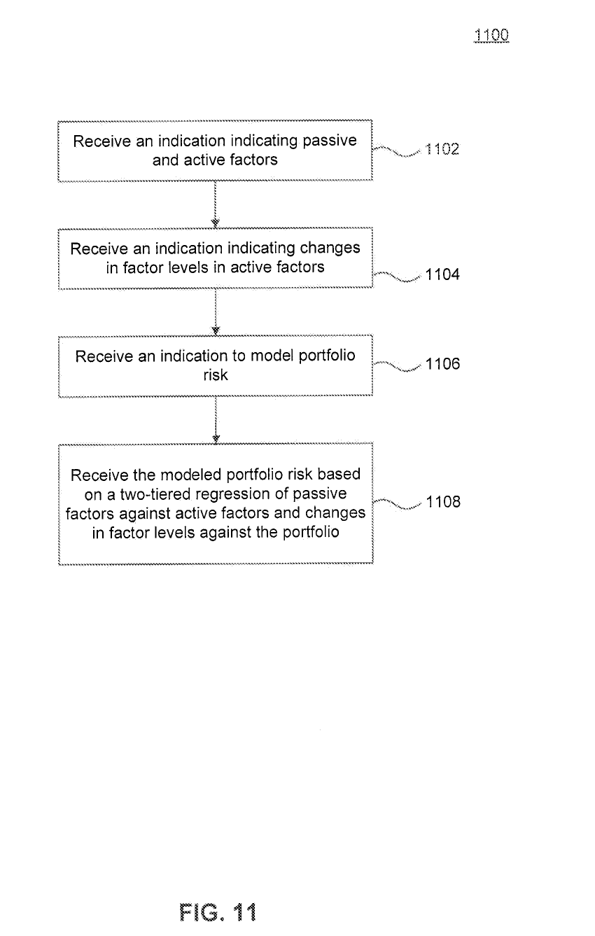

FIG. 11 is a flowchart of a method 1100 for generating a scenario and displaying portfolio risk, according to an embodiment.

At step 1102, an indication indicating which factors are active and passive is received. For example, equalizer 108 may receive an indication from a user using equalizer 108 that sets factors 202 as active factors or passive factors in scenario 302. As described above, the indication may be in a form of a user marking lock indicator 206 associated with factor 202 and identifying passive factor in one embodiment.

At step 1104, an indication indicating changes in factor levels is received. For example, equalizer 108 may receive an indication from a user that causes equalizer 108 to identify factor level changes for an active factor in scenario 302. As described above, the indication may be in the form of a user moving fader bar 204 associated with an active factor.

At step 1106, an indication to model portfolio risk is received. For example, equalizer 108 may receive an indication from a user to model portfolio risk for portfolio 110. In an embodiment, upon receipt of the indication, which may be the selection of a button or other indications known to a person of ordinary skill in the art, client device 104 transmits scenario 302 as set in steps 1102 and 1104 to equalizer backend 112, where equalizer backend 112 models portfolio risk 406 using a two-tiered regression as discussed in FIGS. 8-10.

At step 1108, the determined portfolio risk is received. For example, equalizer 108 may receive portfolio risk 406 from equalizer backend 112. As discussed above, portfolio risk 406 includes the factor level changes as shown in equalizer section 702, risk to a portfolio 110 in aggregate and on a per factor basis as shown in distribution chart 704, and risk to positions 308 in portfolio 110 on a per position basis as shown in positions chart 706.

Various embodiments in FIGS. 1-11 can be implemented, for example, using one or more computer systems, such as computer system 1200 shown in FIG. 12. Computer system 1200 can be any computer capable of performing the functions described herein, such as computers available from International Business Machines (“IBM”), Apple, Sun, Hewlett Packard (“HP”), Dell, Sony, Toshiba, etc.

Computer system 1200 includes one or more processors, such as a processor 1204. Processor 1204 may include any conventional or special purpose processor, including, but not limited to, a digital signal processor (DSP), field programmable gate array (FPGA), or application specific integrated circuit (ASIC). Processor 1204 is connected to a communication infrastructure or bus 1206.

One or more processors 1204 may also be a graphics processing unit (GPU). In an embodiment, a GPU is a processor that is a specialized electronic circuit designed to rapidly process mathematically intensive applications on electronic devices. The GPU may have a highly parallel structure that is efficient for parallel processing of large blocks of data, such as mathematically intensive data common to computer graphics applications, images and videos.

Computer system 1200 also includes user input/output device(s) 1202, such as monitors, keyboards, pointing devices, etc., which communicate with communication infrastructure 1206 through user input/output interface(s) 1203. Example communication infrastructure 1206 may include one or more device interconnection buses such as Ethernet, Peripheral Component Interconnect (PCI), and the like.

Computer system 1200 also includes a main or primary memory 1208, such as random access memory (RAM). Main memory 1208 may include one or more levels of cache. Main memory 1208 has stored therein control logic (e.g., computer software) and/or data.

Computer system 1200 may also include one or more secondary storage devices or memories 1210. Secondary memory 1210 may include, for example, a hard disk drive 1212 and/or a removable storage device 1214. Removable storage drive 1214 may be a floppy disk drive, a magnetic tape drive, a compact disc drive, an optical storage device, tape backup device, USB port, removable memory chip socket, memory card slot, and/or any other storage device/drive.

Removable storage drive 1214 may interact with a removable storage unit 1218. Removable storage unit 1218 includes a computer-readable storage device having stored thereon computer software (control logic) and/or data. The interaction allows computer programs and/or other instructions and/or data to be accessed by computer system 1200. Removable storage unit 1218 may be a floppy disk, magnetic tape, compact disc, DVD, optical storage disk, a removable memory chip (such as an EPROM or PROM), a memory stick, a memory card, and/any other computer data storage device. Removable storage drive 1214 reads from and/or writes to removable storage unit 1218 in a well-known manner.

Computer system 1200 may further include a communication or network interface 1224. Communication interface 1224 enables computer system 1200 to communicate and interact with any combination of remote devices, remote networks, remote entities, etc. (individually and collectively referenced by reference number 1228). For example, communication interface 1224 may allow computer system 1200 to communicate with remote devices 1228 over communications path 1226, which may be wired and/or wireless, and which may include any combination of local area networks (LANs), wide area networks (WANs), the Internet, etc. Control logic and/or data may be transmitted to and from computer system 1200 via communication path 1226.

In an embodiment, a tangible apparatus or article of manufacture comprising a computer-readable medium having control logic (software) stored thereon is also referred to herein as a computer program product or program storage device. This includes, but is not limited to, computer system 1200, main memory 1208, secondary memory 1210, and removable storage units 1218, as well as tangible articles of manufacture embodying any combination of the foregoing. Such control logic, when executed by one or more data-processing devices (such as computer system 1200), causes such data-processing devices to operate as described herein.

Based on the teachings contained in this disclosure, it will be apparent to persons skilled in the relevant art(s) how to make and use the invention using data-processing devices, computer systems and/or computer architectures other than that shown in FIG. 12. In particular, embodiments may operate with software, hardware, and/or operating system implementations other than those described herein.

### CONCLUSION

While the invention has been described herein with reference to exemplary embodiments for exemplary fields and applications, it should be understood that the invention is not limited thereto. Other embodiments and modifications thereto are possible, and are within the scope and spirit of the invention. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof The boundaries of these functional building blocks have been arbitrarily defined herein for the convenience of the description. Alternate boundaries can be defined as long as the specified functions and relationships (or equivalents thereof) are appropriately performed. Also, alternative embodiments may perform functional blocks, steps, operations, methods, etc. using orderings different than those described herein.

References herein to “one embodiment,” “an embodiment,” “an example embodiment,” or similar phrases indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein.

The breadth and scope of the invention should not be limited by any of the above-described exemplary embodiments, but should be defined only in accordance with the following claims and their equivalents.

Embodiments may also be directed to computer program products comprising software stored on any computer-usable or computer-readable storage medium. Such software, when executed in one or more data-processing device, causes a data-processing device(s) to operate as described herein. Embodiments of the invention employ any computer-useable or computer-readable storage medium. Examples of computer-readable storage mediums include, but are not limited to, primary storage devices (e.g., any type of random access memory) and secondary storage devices (e.g., hard drives, floppy disks, CD-ROMS, ZIP disks, tapes, magnetic storage devices, and optical storage devices, MEMS, nanotechnological storage device, etc.).

The embodiments have been described above with the aid of functional building blocks illustrating the implementation of specified functions and relationships thereof The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, and without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The Summary and Abstract sections may set forth one or more but not all exemplary embodiments of the present invention as contemplated by the inventor(s), and thus, are not intended to limit the present invention and the appended claims in any way.

What is claimed is:

1. A system comprising:
a processor;
a memory coupled to the processor;
an equalizer backend, stored in the memory, configured to execute on the processor and model portfolio risk, the equalizer backend comprising:
a factor analyzer configured to:
receive a scenario, wherein the scenario includes a passive factor and an active factor; and
apply a first regression to the passive factor and the active factor, wherein the passive factor is regressed against the active factor and determines a change in a passive factor level; and
a portfolio analyzer configured to:
apply a second regression that determines the portfolio risk by applying the change in the passive factor level and a change in an active factor level to a portfolio.

2. The system of claim 1, wherein the scenario further includes the change to the active factor level.

3. The system of claim 2, wherein in applying the first regression, the factor analyzer is further configured to:
determine a regression coefficient for the passive factor based on a historical data associated with the passive factor regressed against a historical data associated with the active factor; and
determine the change in the passive factor level, wherein the change in the passive factor level is a function of the regression coefficient and the change in the active factor level.

4. The system of claim 2, wherein the factor analyzer is further configured to:
store the regression coefficient for the passive factor for the scenario;
receive a second scenario;
determine whether there was a change in the passive factor and the active factor between the scenario and the second scenario; and
if the passive and active factors are the same, retrieve the regression coefficient for the passive factor without performing the first regression on the second scenario; or
if the passive and active factors are different, apply the first regression to the second scenario.

5. The system of claim 1, wherein the factor analyzer is further configured to apply the first regression based on monthly intervals of the historical data associated with the passive factor and the historical data associated with the active factor.

6. The system of claim 1, wherein the factor analyzer is further configured to apply the first regression based on daily intervals of the historical data associated with the passive factor and the historical data associated with the active factor.

7. The system of claim 1, wherein the factor analyzer is further configured to apply the first regression based on a configurable number of days of the historical data associated with the passive factor and the historical data associated with the active factor.

8. The system of claim 1, wherein the portfolio analyzer is further configured to apply the second regression to the portfolio on per position basis.

9. The system of claim 1, wherein to apply the second regression, the portfolio analyzer is further configured to:
for a position in a plurality of positions in the portfolio, determine a risk for the position based on a sensitivity coefficient associated with the position and the changes in the passive and active factor levels due to the passive factor and the active factor;
aggregate the risk for the position due to the active factor and the passive factor; and
determine the portfolio risk based on the aggregated risk.

10. The system of claim 9, wherein to determine the risk for the position, the portfolio analyzer is further configured to:
determine a factor contribution for the risk for the position, wherein the factor contribution is a dot product between the sensitivity coefficient associated with the position and the changes in the passive and active factor levels; and
perform a linear combination of weight for the position multiplied by the factor contribution, wherein the linear combination identifies the risk for the position due to the changes in the passive and active factor levels.

11. The system of claim 1, wherein a number of factors in the scenario is configurable.

12. The system of claim 1, wherein the passive factor and the active factor simulate market conditions.

13. A method for modeling portfolio risk, the method comprising:
receiving a scenario, wherein the scenario includes a passive factor and an active factor;
applying a first regression to the passive factor and the active factor, wherein the passive factor is regressed against the active factor and determines a change in a passive factor level; and
applying a second regression that determines the portfolio risk by applying the change in the passive factor level and a change in an active factor level to a portfolio.

14. The method of claim 13, wherein the scenario farther includes the change to the active factor level.

15. The method of claim 14, wherein applying the first regression further comprises:
determining a regression coefficient for the passive factor based on a historical data associated with the passive factor regressed against a historical data associated with the active factor; and
determining the change in the passive factor level, wherein the change in the passive factor level is a function of the regression coefficient and the change in the active factor level.

16. The method of claim 13, further comprising:
storing the regression coefficient for the passive factor for the scenario;
receiving a second scenario;
determining whether there was a change in the passive factor and the active factor between the scenario and the second scenario; and
if the passive and active factors are the same, retrieving the regression coefficient for the passive factor without performing the first regression on the second scenario; or
if the passive and active factors are different, applying the first regression to the second scenario.

17. The method of claim 13, wherein applying the first regression further comprises applying the first regression based on monthly intervals of the historical data associated with the passive factor and the historical data associated with the active factor.

18. The method of claim 13, wherein applying the first regression further comprises applying the first regression based on daily intervals of the historical data associated with the passive factor and the historical data associated with the active factor.

19. The method of claim 13, wherein applying the first regression further comprises applying the first regression based on the configurable number of days of the historical data associated with the passive factor and the historical data associated with the active factor.

20. The method of claim 13, wherein applying the second regression further comprises applying the second regression to the portfolio on per position basis.

21. The method of claim 13, wherein applying the second regression further comprises: for a position in a plurality of positions in the portfolio, determining a risk for the position based on a sensitivity coefficient associated with the position and the changes in the passive and active factor levels due to the passive factor and the active factor;
aggregating the risk for the position due to the active factor and the passive factor; and
determining the portfolio risk based on the aggregated risk.

22. The method of claim 21, wherein determining the risk for the position comprises:
determining a factor contribution for the risk for the position, wherein the factor contribution is a dot product between the sensitivity coefficient associated with the position and the changes in the passive and active factor levels; and
performing a linear combination of weight for the position multiplied by the factor contribution, wherein the linear combination identifies the risk for the position due to the changes in the passive and active factor levels.

23. The method of claim 13, wherein a number of factors in the scenario is configurable.

24. The method of claim 13, wherein the passive factor and the active factor simulate market conditions.

25. A computer-readable storage medium having instructions stored thereon that, when executed by a processor, cause the processor to:
receive a scenario, wherein the scenario includes a passive factor and an active factor;
apply a first regression to the passive factor and the active factor, wherein the passive factor is regressed against the active thaw and determines a change in a passive factor level; and
apply a second regression that determines the portfolio risk by applying the change in the passive factor level and a change in an active factor level to a portfolio.
